(19) United States
(12) Patent Application Publication
(10) Pub. No.: US 2024/0014465 A1
(43) Pub. Date: Jan. 11, 2024

(54) Battery Pack

(71) Applicant: Hyperdrive Innovation Limited, Sunderland (GB)

(72) Inventors: Dave Sandells, Sunderland (GB); Stephen Irish, Sunderland (GB); Jason Lovell, Sunderland (GB)

(21) Appl. No.: 18/020,050

(22) PCT Filed: Aug. 6, 2021
(86) PCT No.: PCT/GB2021/052040

§ 371 Date: Feb. 6, 2023

(30) Foreign Application Priority Data
Aug. 6, 2020 (GB) 2012275.0

(51) Int. Cl. H01M 10/6563; H01M 10/48; H01M 10/613; H01M 10/625; H01M 10/63; B60L 58/26

(52) U.S. Cl. CPC H01M 10/6563; H01M 10/482; H01M 10/486; H01M 10/613; H01M 10/625; H01M 10/63; B60L 58/26; H01M 2220/20; B60L 2240/545

(57) ABSTRACT

A battery pack is disclosed herein. The battery pack comprises an enclosure housing at least one stack of battery cells, and active cooling means configured to blow air over the at least one stack of battery cells in a first airflow direction through the enclosure and a second airflow direction through the enclosure opposite to the first airflow direction. The active cooling means is coupled to a controller. The controller is configured to control the active cooling means to alternate between the first airflow direction and the second airflow direction based on a parameter indicative of the temperature of the at least one stack of battery cells.

### RELATED APPLICATIONS

This application is a 35 U.S.C. 371 National Stage Entry of International Application No. PCT/GB2021/052040, filed Aug. 6, 2021, and claims the benefit of United Kingdom Patent Application GB2012275.0, filed Aug. 6, 2020, each of which is incorporated herein by reference in their entirety for all purposes as if fully set forth herein.

### FIELD OF THE INVENTION

The present disclosure relates to a battery pack such as a battery pack for use with rolling stock, wherein the battery pack has active cooling means.

### BACKGROUND

Transport systems around the world are becoming increasingly electrified. In many instances this requires the use of batteries to store electrical power and deliver it when the vehicle is not connected to an electrical grid system. The applications of the battery systems, and the need for as fast charge times as possible, however, places demands on the batteries. For example, fast charge and discharge cycles create large amounts of heat in the cells of the batteries that can potentially damage the battery cells and potentially even lead to a fire. As such, it is desirable to cool battery cells to limit the potentially damaging heating effects. Conventional systems for cooling battery cells, however, are relatively bulky and as such it is difficult to achieve the desired energy densities required for many applications such as for rolling stock.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

Embodiments of the disclosure provide battery packs comprising battery cells arranged in at least one stack in an enclosure, and whereby active cooling means are arranged to cool the cells alternately from one side and another side. In some examples of the disclosure the battery packs comprise at least two stacks of battery cells, and the active cooling means is arranged to predominantly cool one of the stacks first, and the predominantly cool the other one of the stacks after. The cooling of the first and second stacks may alternate continuously while the cells are being charged and/or discharged. In some examples of the disclosure the battery packs are specifically adapted for use with rolling stock. In such examples the battery packs may comprise a fire-proof or fire-rated enclosure, and a plurality of such battery packs may be coupled together inside a hermetically sealed enclosure. Providing the battery packs in such a hermetically sealed enclosure may improve the service life of the battery packs and the active cooling means as the hermetic enclosure will inhibit the ingress of dirt and contaminants, as well as provide an additional degree of safety in inhibiting the spread of fire.

Advantageously, battery packs of the disclosure therefore offer improved cooling in a relatively smaller form factor. As such, the energy density of battery packs can be improved, while at the same time limiting the potentially damaging effects excessive temperatures may place on the battery cells.

Accordingly in a first aspect there is provided a battery pack comprising an enclosure housing at least one stack of battery cells and active cooling means configured to blow air over the at least one stack of battery cells in a first airflow direction through the enclosure and a second airflow direction through the enclosure opposite to the first airflow direction. The active cooling means is coupled to a controller and wherein the controller is configured to control the active cooling means to alternate between the first airflow direction and the second airflow direction based on a parameter indicative of the temperature of the at least one stack of battery cells. As will be described in more detail below, it will be understood that the active cooling means may, for example, comprise a single fan or a pair of opposing fans. For example, the pair of opposing fans may be at opposite ends of the enclosure.

The battery pack may comprise a first stack of battery cells and a second stack of battery cells, and wherein the active cooling means comprises a first fan configured to blow air predominantly over the first stack of battery cells in the first airflow direction, and a second fan configured to blow air predominantly over the second stack of battery cells in the second airflow direction. In such examples the controller may be configured to determine whether to control the active cooling means to blow air predominantly over the first stack of battery cells or the second stack of battery cells based on a temperature differential between the first stack of battery cells and the second stack of battery cells.

The controller may be configured to operate in two modes:
in a first mode where the active cooling means are not powered when the parameter indicative of the temperature indicates that the temperature of the cells is below a selected temperature threshold; and
in a second mode where the controller controls the direction of airflow from the active cooling means based on a parameter indicative of the temperature of the at least one stack of battery cells when the parameter indicative of the temperature indicates that the temperature of the cells is equal to and/or above the selected temperature threshold. For example, the controller may operate in the first mode when the battery packs are first used—for example charge or discharge has only just begun and so that battery cells are still relatively cool. The controller may therefore operate in the second mode when the battery packs have already been in use for a period of time such that they have become relatively warm.

The parameter indicative of a temperature may comprise at least one of:
the current draw from the battery cells;
a selected time interval;
   a temperature gradient across the cells of the battery cells; and
   whether the cells are being charged or discharged and optionally the duration of the charge or discharge.

The controller may be configured to determine the temperature of the cells of the battery pack based on an indication of whether the cells and being charged or discharged and the corresponding current flow to/from the cells, and by referencing a lookup table listing known relationships between duration of charge and discharge, current flow and temperature.

The controller may further be configured to control the active cooling means based on ambient temperature.

The controller may be configured to operate the active cooling means to blow air in each direction for at least a selected threshold minimum period of time. For example, the threshold minimum period of time could be enough to allow the fan to get up to its normal operating speed. In some examples the controller may also be configured operate the active cooling means to blow air in each direction for less than or equal to a selected threshold maximum period of time.

In some examples where the active cooling means comprise a first fan and a second fan, the first fan may be configured to blow air over a corresponding first heat exchanger and the second fan is configured to blow air over a corresponding second heat exchanger. Optionally the heat exchanger may be located between each fan and a corresponding stack of battery cells, so for example the first fan may be configured to blow air over the first heat exchanger (where, for example, it is cooled) and then onto the first stack of battery cells, and the second fan may be configured to blow air over the second heat exchanger (where, for example, it is also cooled) and then onto the second stack of battery cells.

The active cooling means and orientation of the at least one stack of battery cells may be arranged so that the active cooling means blows air along a thin edge of each cell of the stack of battery cells

In some examples where the active cooling means comprise a first fan and a second fan, the controller is configured to control the two fans so that they either both blow air in the first airflow direction or both blow air in the second airflow direction.

In some examples where the active cooling means comprise a first fan and a second fan, the controller is configured to control the first fan and second fan such that when the controller controls the first fan to blow air in the first airflow direction the second fan is not operating, and when the controller controls the second fan to blow air in the second airflow direction the first fan is not operating. In some examples the controller is configured to operate both fans for a selected period of time when the first fan is being run up to a first fan selected operating speed and the second fan is being run down from a second fan selected operating speed, or when the second fan is being run up to the second fan selected operating speed and the first fan is being run down from the first fan selected operating speed.

The enclosure may be elongate such that an elongate dimension is greater than the other dimensions, and wherein the first and second airflow directions are parallel to the elongate dimension. The active cooling means (such as a pair of fans) may be provided at opposing ends (in the elongate dimension) of the enclosure.

In another aspect there is provided hermetic enclosure comprising a plurality of the battery packs as described above.

It will be understood that the hermetic enclosure may comprise the controller, and the controller may be a master controller common to the plurality of battery packs. However alternatively each battery pack may comprise a respective controller for controlling its corresponding active cooling means. Each respective battery pack may comprise a corresponding heat exchanger fed with a common coolant common to all of the battery packs in the hermetic enclosure.

In another aspect there is provided power pack for providing electric power to rolling stock. The power pack comprises a hermetic enclosure housing a plurality of battery packs. Each battery pack comprises an enclosure housing at least one stack of battery cells, and active cooling means configured to blow air through the enclosure over the at least one stack of battery cells in a first airflow direction and a second airflow direction opposite to the first airflow direction.

The power pack may further comprise a master controller configured to control the active cooling means of the plurality of battery packs to alternate between the first airflow direction and the second airflow direction based on a parameter indicative of the temperature of the at least one stack of battery cells of each battery pack. The master controller may be configured to independently control the active cooling means of each battery pack. However alternatively each battery pack may comprise a respective controller for controlling its corresponding active cooling means.

In another aspect there is provided a method of operating a power pack for rolling stock, the power pack comprising a hermetic enclosure housing a plurality of battery packs, wherein each battery pack comprises an enclosure housing at least one stack of battery cells, and active cooling means. The method comprising operating the active cooling means to blow air through the enclosure over the at least one stack of battery cells in a first airflow direction and then operating the active cooling means to blow air through the enclosure over the at least one stack of battery cells in a second airflow direction opposite to the first airflow direction.

The method may comprise operating the active cooling means to blow air in the first airflow direction and the second airflow direction based on a parameter indicative of the temperature of the battery cells of each pack. The parameter indicative of the temperature of the battery cells of each pack may comprise a torque demand of the rolling stock.

In some examples the method may comprise controlling the active cooling means of each pack based on an indication of a temperature of the corresponding battery cells in each pack.

In some examples the method may comprise controlling the active cooling means of all of the plurality of battery packs based on an indication of an average temperature of the battery cells of the plurality of battery packs.

In some examples each battery pack comprises at least two stacks of battery cells, and controlling the active cooling means may comprise controlling the active cooling means to predominantly cool the first stack of battery cells and then controlling the active cooling means to predominantly cool the second stack of battery cells. In such examples the method may comprise determining whether to control the active cooling means to predominantly cool the first or second stack of battery cells based on a temperature differential between the first and second stack of battery cells.

The method may comprise operating the active cooling in means in two modes:
in a first mode where the active cooling means are not powered when the parameter indicative of the temperature indicates that the temperature of the cells is below a selected temperature threshold; and
in a second mode where the direction of airflow from the active cooling means is controlled based on a parameter indicative of the temperature of the at least one stack of battery cells when the parameter indicative of the temperature indicates that the temperature of the cells is equal to and/or above the selected temperature threshold.

In another aspect there is provided a method of operating active cooling means for a battery pack, the active cooling means arranged to blow air through an enclosure housing at least two stacks of battery cells in a first airflow direction and a second airflow direction opposite to the first airflow direction, the method comprising:
controlling the active cooling means to predominantly cool the first stack of battery cells; and then
controlling the active cooling means to predominantly cool the second stack of battery cells.

The method may comprise operating the active cooling means based on a parameter indicative of the temperature of the battery cells of each pack.

The method may comprise controlling the active cooling means to predominantly cool the first or second stack of battery cells based on a temperature differential between the first and second stack of battery cells.

In some examples the method comprises operating the active cooling in means in two modes;

in a first mode where the active cooling means are not powered when the parameter indicative of the temperature indicates that the temperature of the cells is below a selected temperature threshold; and

in a second mode where the direction of airflow from the active cooling means is controlled based on a parameter indicative of the temperature of the at least one stack of battery cells when the parameter indicative of the temperature indicates that the temperature of the cells is equal to and/or above the selected temperature threshold.

In another aspect there is provided a computer readable non-transitory storage medium comprising a program for a computer configured to cause a processor to perform any of the methods described above.

### DRAWINGS

Embodiments of the disclosure will now be described, by way of example only, with reference to the accompanying drawings, in which:

FIG. 1A shows a cross-section plan view of an example battery pack with air flowing through the pack in a first direction;

FIG. 1B shows a cross-section plan view of the example battery pack of FIG. 1A with the air flowing through the pack in a second direction opposite to the first direction;

FIG. 2 shows a cross-section plan view of an example power pack for providing electric power to rolling stock, comprising a plurality of battery packs such as the battery pack of FIGS. 1A and 1B;

FIG. 3 shows a cross-section plan view of another example battery pack;

FIG. 4 shows a cross-section plan view of another example battery pack;

FIG. 5 shows a cross-section plan view of another example battery pack;

FIG. 6 shows a cross-section plan view of another example battery pack;

FIG. 7 shows a cross-section plan view of another example battery pack; and

FIG. 8 shows a graph illustrating the temperature of cells in the battery back when cooled using methods of the disclosure comprising alternating the direction of cooling airflow compared to methods where the direction of cooling airflow is kept constant.

### SPECIFIC DESCRIPTION

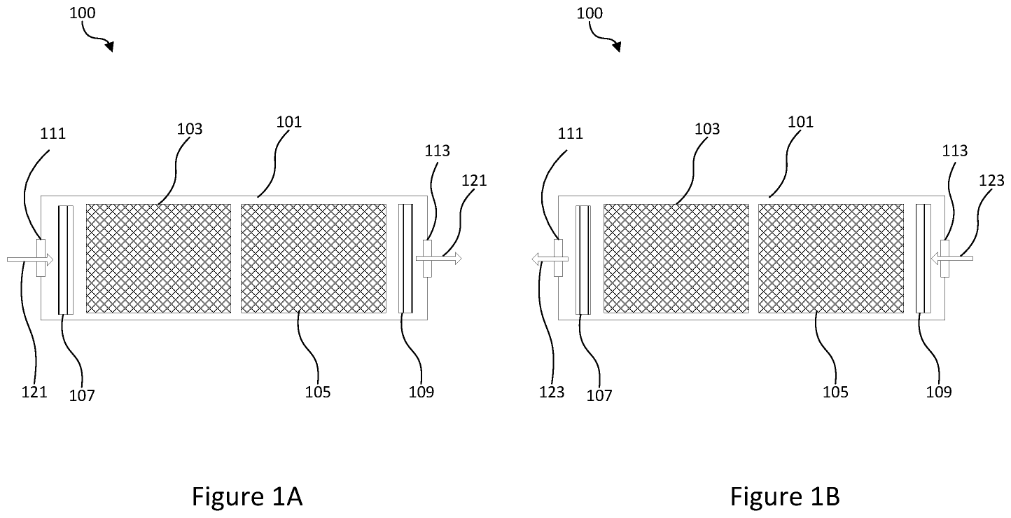

FIGS. 1A, 1B and 3 to 7 all show cross-section plan views of example battery packs of the disclosure, where active cooling means such as a fan are arranged to cool battery cells arranged in stacks in an enclosure. In the examples shown in FIGS. 1A, 1B and 3 to 7, the air is blown over a heat exchanger or similar means to cool the air, however it will be understood that in some examples such a heat exchanger is not required.

FIGS. 1A and 1B show a cross-section plan view of an example battery pack 100 of the disclosure. The battery packs 100 shown in FIGS. 1A and 1B are identical other than the active cooling means 111, 113 (which in this example are fans) are controlled to operate in alternate directions, such that in the example of FIG. 1A air is blown 121, 123 by both active cooling means in a first direction, and in the example of FIG. 1B air is blown 121, 123 by both active cooling means 111, 113 in a second direction opposite to the first direction. The cross-section plan view in FIGS. 1A and 1B shows the battery packs 100 as viewed from above.

As shown in FIGS. 1A and 1B, the battery pack 100 comprises an enclosure 101 housing two stacks 103, 105 of battery cells—a first stack 103 and a second stack 105. The enclosure 101 may be made from metal and may be fire retardant, so as to inhibit the spread of fire if any of the cells of the battery pack 100 were to ignite.

Each stack 103, 105 of battery cells comprises a plurality of identical battery cells stacked on above the other. The cells of each stack 103, 105 may be supported or separated by a supporting means, such as a cassette or similar mechanism arranged to hold the battery cells in a stack, where the cells may be separated from each such that there is an airflow gap between them. The cells of each stack 103, 105 are rectangular and planar, such that they are relatively thin and flat and rectangular in shape when viewed from above, with one dimension (thickness) being much less in magnitude than the other two dimensions. The two stacks 103, 105 are arranged adjacent to each other and end-to-end with a small gap (for air flow) between them. As such, the two stacks 103, 105 positioned adjacent to each other end-to-end form an elongated rectangle having a longitudinal axis.

The enclosure 101 is designed to minimise the form factor of the battery packs and closely follows this elongated rectangle shape formed by the two stacks 103, 105 of battery cells placed end-to-end, such that the enclosure 101 is also rectangular and elongate having an elongate dimension greater than any other dimension (and wherein the elongate dimension is in the same direction as the longitudinal axis), but is slightly longer in the elongate dimension (i.e. along the longitudinal axis) than the two stacks 103, 105 such that there is a cavity or space inside the enclosure 101 at either end of the two stacks 103, 105. In the example shown in FIGS. 1A and 1B, at either end of the two stacks 103, 105, there is a respective heat exchanger 107, 109 in this cavity. The heat exchangers 103, 105 are also rectangular in shape but arranged to extend the depth of the two stacks 103, 105 of battery cells. As such, the heat exchangers 107, 109 have a height substantially corresponding to that of each stack 103, 105 of battery cells, and a width substantially corresponding to that of the width of the cells of each stack 103, 105 of battery cells, but a length (in the elongate direction or along the longitudinal axis of the enclosure 101) that is much less than that of the length of the battery cells of each stack 103, 105. As such, the battery cells of each stack 103, 105 are substantially planar in shape in a plane parallel to the longitudinal axis of the enclosure 101, but the heat exchangers 107, 109 are substantially planar in shape in a plane transverse to (and in the example shown, perpendicular to) the longitudinal axis of the enclosure 101.

At either end of the enclosure 101 (in the elongate direction or along the longitudinal axis) there is an aperture in the enclosure 101, and inside each aperture is an active cooling means, which in the example shown are fans. The enclosure 101 therefore comprises a first fan 111 at a first end of the enclosure 101, and a second fan 113 at a second end of the enclosure. Although not shown in FIGS. 1A and 1B, the fans 111, 113 are coupled to a controller. The controller may be local to the enclosure 101 (for example the enclosure 101 may comprise the controller, for example such that the controller may be inside the enclosure 101) or the controller may be external to the enclosure 101.

The fans 111, 113 are each configured to blow air either into or out of the enclosure 101. In the example shown in FIG. 1A, the first fan 111 is configured to blow air into and through the enclosure 101 over the first heat exchanger 107 and predominantly the first stack 103 of battery cells in a first airflow direction 121 as shown in FIG. 1A, or out for the enclosure 101 in a second airflow direction 123 opposite to the first airflow direction 121 as shown in FIG. 1B. The first and second airflow directions 121, 123 are parallel to the elongate dimension.

Similarly, the second fan 113 is configured to blow air into and through the enclosure 101 over the second heat exchanger 109 and predominantly the second stack 105 of battery cells in the second airflow direction 123 as shown in FIG. 1B (which is the same direction as the second airflow direction 123 of the first fan 111), or as shown in FIG. 1A, out of the enclosure 101 in a first airflow direction 121 opposite to the second airflow direction 123 (which is in the same direction as the first airflow direction 121 of the first fan 111).

The orientation and positions of the first and second fans 111, 113, and orientation and positioning of the two stacks 103, 105 of battery cells is arranged so that the fans 111, 113 are arranged to blow air along a thin edge of each cell of the stacks 103, 105 of battery cells.

In the example shown in FIGS. 1A and 1B, the controller is configured to determine whether to control the fans 111, 113 to blow air predominantly over the first stack 103 of battery cells or the second stack 105 of battery cells based on a temperature differential between the first stack 103 of battery cells and the second stack 105 of battery cells. The temperature differential may be directly measured or may be inferred or determined based on other parameters, for example a parameter indicative of a temperature comprising at least one of:
the current draw from the battery cells;
a selected time interval;
   a temperature gradient across the cells of the battery cells; and
   whether the cells are being charged or discharged and optionally the duration of the charge or discharge.

For example, the controller may be configured to determine the temperature of the cells of the battery pack 100 based on an indication of whether the cells and being charged or discharged and the corresponding current flow to/from the cells, and by referencing a lookup table listing known relationships between duration of charge and discharge, current flow and temperature. For example, based on previous usage and/or known relationships, the controller may be configured to determine the temperature of the cell based on a current flow to/from the battery cells as a function of time.

In use, the controller controls the fans 111, 113 to first predominantly cool the first stack 103 of battery cells, and then controls the fans 111, 113 to predominantly cool the second stack 105 of battery cells based on a parameter indicative of the temperature of the battery cells of each stack 103, 105.

The controller may be configured to control both fans to operate at the same time in the same airflow direction (as shown in FIGS. 1A and 1B) or to alternate when they are operated.

In the example shown in FIG. 1A, when the controller controls the fans 111, 113 to predominantly cool the first stack 103 of battery cells, the first fan 111 is controlled to blow in the first airflow direction 121 and the second fan 113 is also controlled to blow air in the first airflow direction 121. This means that the second fan 113 is actually operating in reverse to the first fan 111. Likewise, when the controller controls the fans 111, 113 to predominantly cool the second stack 104 of battery cells, the first fan 111 is controlled to blow in the second airflow direction 123 and the second fan 113 is also controlled to blow air in the second airflow direction 123. This means that the first fan 111 is actually operating in reverse to the second fan 113.

However, in other examples the controller is configured to control the first fan 111 and second fan 113 such that when the controller controls the first fan 111 to blow air in the first airflow direction 121 the second fan is not operating, and when the controller controls the second fan to blow air in the second airflow direction the first fan is not operating. In this way only one fan 111, 113 may be operated or powered at a time.

In the example shown in FIGS. 1A and 1B, the controller is configured to operate in two modes. In a first mode, such as when the battery pack 101 is initially being used (i.e. initially being charged or discharged) the fans 111, 113 are not powered. This may be when the parameter indicative of the temperature indicates that the temperature of the cells is below a selected temperature threshold. In a second mode, such as when the battery pack 101 has been in use for a selected time period, the controller controls the direction of airflow from the fans 111, 113 based on a parameter indicative of the temperature of the at least one stack 103, 105 of battery cells (for example, in the manner described above) when the parameter indicative of the temperature indicates that the temperature of the cells is equal to and/or above the selected temperature threshold.

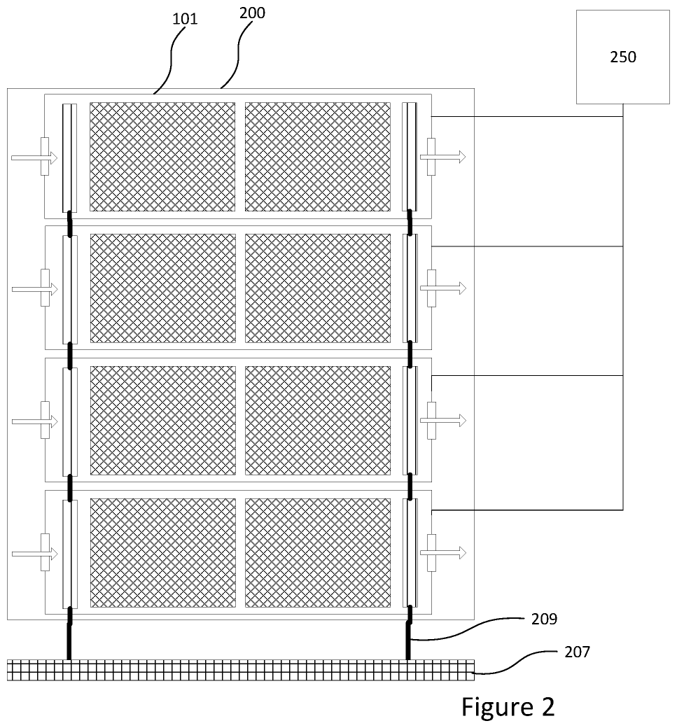

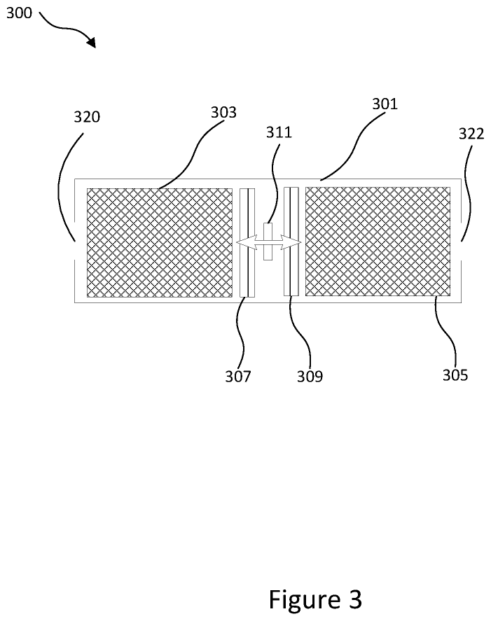

FIG. 2 shows an example power pack 200 for providing electric power to rolling stock. The power pack 200 comprises a plurality of battery packs 100 arranged inside a common enclosure 200, which in this example is a hermetic enclosure. The hermetic enclosure may be IP rated and be fire retardant/configured to inhibit the spread of fire. The battery packs 100 may be the same battery packs 100 as those described in relation to FIGS. 1A and 1B, or as will be described below with respect to FIGS. 3 to 7. The battery packs are arranged side by side, with the longitudinal axis of each battery pack parallel to the longitudinal axis of the others. This orientation may be advantageous to minimise the form factor of the power pack 200 and yet still provide a small space or cavity at the end of each battery pack 100 for air to circulate so that it can be blown into or out of each battery pack 100 to cool the battery cells contained therein.

In the example shown, each battery pack 100 is coupled to a common (master) controller 250. In the example shown in FIG. 2, the master controller 250 is outside of the hermetic enclosure of the power pack 200, but in some examples the power pack 200 may comprise the master controller 250 inside the hermetic enclosure. The master controller 250 may provide the functionality of the controller described above for the battery packs 100 of FIGS. 1A and 1B. However, it will be understood that additionally or alternatively each battery pack 100 may have a respective controller for controlling its corresponding active cooling means (such as the fans 111, 113).

In the example shown in FIG. 2, the respective heat exchangers 107, 109 of each battery pack 100 are fed by a common coolant, such that the battery pack 100 are fed by the common coolant via a common coolant supply 209. The common coolant supply 209 is coupled to another heat exchange means 207 (such as a radiator) outside of the hermetic enclosure of the power pack 200.

It will be understood that in some examples a plurality of power packs 200 as shown in FIG. 2 may be used for providing electric power to rolling stock. In such examples a master controller 250 may be coupled to the plurality of power packs 200, or each power pack 200 may have a respective master controller 250.

As with the operation of the battery packs 100 described above in relation to FIGS. 1A and 1B, the master controller 250 may control the fans of all of the battery packs 100 to blow air through the enclosure 101 of each battery back 100 over the two stacks 103, 105 of battery cells in a first airflow direction 121 and then to blow air through the enclosure 101 of each battery pack 100 over the two stack 103, 105 of battery cells in a second airflow direction 123 opposite to the first airflow direction based on a parameter indicative of the temperature of the battery cells of each pack. The fans 111, 113 of each battery pack may be controlled on a “global” level based on an average temperature indication of all of the battery packs 100, or the fans 111, 113 of each battery pack 100 may be controlled individually based on the temperature indication of its respective battery cells.

It will be understood that in the use case of rolling stock, the parameter indicative of the temperature of the battery cells of each pack comprises a torque demand of the rolling stock. For example, if a higher torque demand is desired it can be inferred that there will be a greater current draw from the battery packs and therefore that the temperature of the cells of the battery packs is likely to rise accordingly. The controller may be configured to refer to a lookup table the reference torque demand against temperature and/or current draw.

FIG. 3 shows another example battery pack 300. The battery pack 300 is in many respects similar to the battery pack 100 shown in FIGS. 1A and 1B, and like reference numbers denote similar features. However, in the example shown in FIG. 3, there is a single fan 311 located in the middle of the battery pack 300 between the two stacks 303, 305 of battery cells. Between the central fan 311 and the two stacks 303, 305 of battery cells is a respective heat exchanger 307, 309. At either end of the elongate enclosure 301 of the battery pack 300, rather than a fan as shown in FIGS. 1A and 1B, there is an aperture 320, 322. The aperture 320, 322 at each end of the enclosure is configured to allow air to flow into or out of the enclosure at that respective end.

The central fan 311 is configured to operate in forward or reverse, such that the fan 311 can operate to blow air in a first direction over one of the heat exchangers 307, 309 and predominantly over one of the stacks 103, 105 of battery cells and through the corresponding aperture 320, 322, and then blow air in a second direction opposite to the first direction to blow air over the other one of the heat exchangers 307, 309 and predominantly over the other one of the stacks 103, 105 of battery cells and through the corresponding aperture 320, 322.

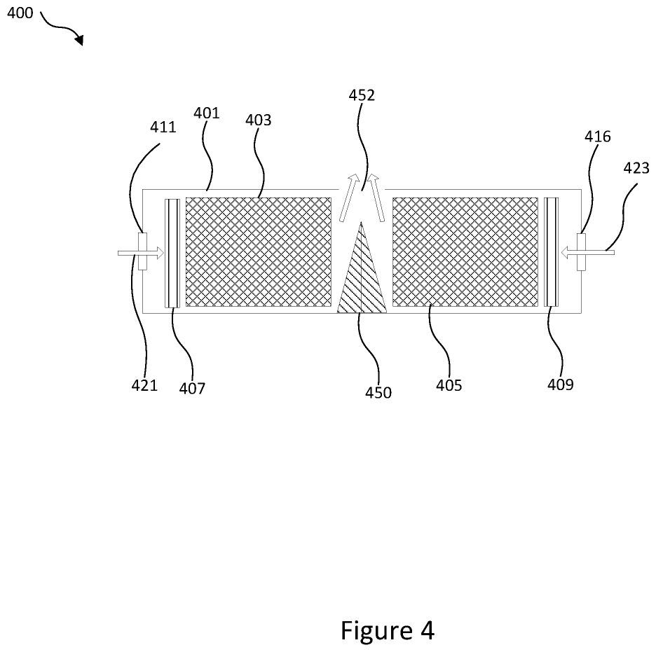

FIG. 4 shows another example battery pack 400. The battery pack 400 is in many respects similar to the battery pack 100 shown in FIGS. 1A and 1B, and like reference numbers denote similar features. However, in the example shown in FIG. 4, there is an aperture 452 located in the centre of the enclosure 401 along a side wall of the enclosure 401 that is parallel to the elongate direction, with an airflow director 450 opposite the aperture to direct airflow out through the aperture 452. In the example shown the airflow director 450 is triangular or wedge-shaped, but it will be understood that other shapes may be used to direct air out through the aperture 452. In this example both fans 411, 413 could therefore be operating in opposite directions at the same time. However, a disadvantage of this embodiment is that if the battery packs 400 were to be used in a power pack 200 such as described in FIG. 2, there would need to be an additional space adjacent to the aperture 452 to allow airflow to circulate. As such, if the battery pack 400 were to be used in a power pack it might take up more space (as the battery packs 400 would have to be spaced further apart) and consequently have a larger form factor.

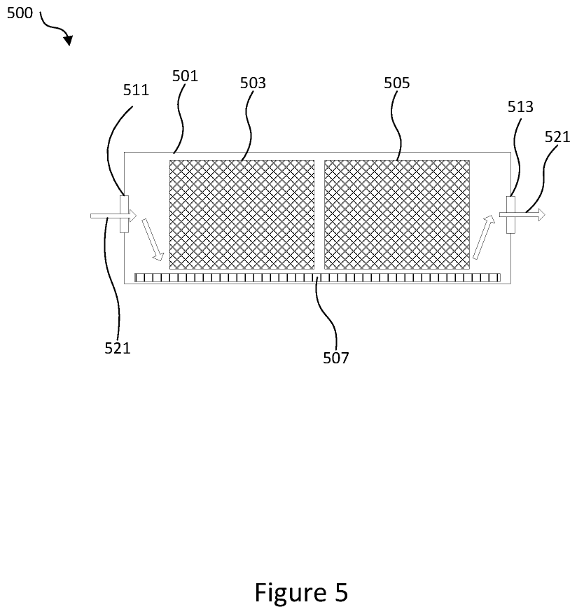

FIG. 5 shows another example battery pack 500. The battery pack 500 is in many respects similar to the battery pack 100 shown in FIGS. 1A and 1B, and like reference numbers denote similar features. However, in the example battery pack 500 of FIG. 5, rather than having respective heat exchangers 107, 109 at each end of the enclosure 501, in the example shown in FIG. 5 there may be a heat exchanger 507 located along one edge of the enclosure 501. The heat exchanger 507 may extend for substantially the length of the two stacks 503, 505 of battery cells.

As described above, the arrangement of the battery cells of each stack 103, 105 may be arranged so that air is directed along a thin edge of each cell and over the planar surface of each side of the cell. In the examples shown in FIGS. 1 to 5 and 7, the cells are arranged in a stacked orientation where, when viewed from above, the cells appear planar and rectangular, having relatively larger width and length dimensions in the plane of the paper when viewed but a depth into the plane of the paper that is of much less magnitude when viewed from above.

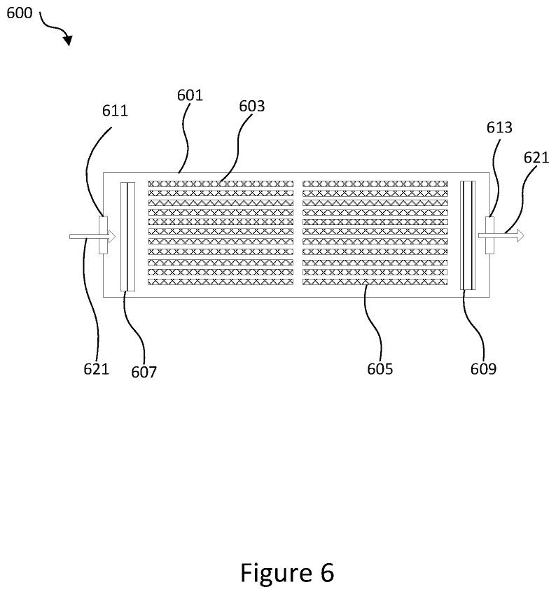

It will be understood that the arrangement of battery cells of each stack 103, 105 may therefore be stacked in a different (perpendicular) orientation and yet air may still be directed along a thin edge of each cell and between and over the planar surface of each side of each battery cell. In the example shown in FIG. 6 the battery cells of each stack 603, 605 are arranged perpendicular to that in FIGS. 1 to 5 and 7, such that the thin edge of each cell is viewed when viewed from above.

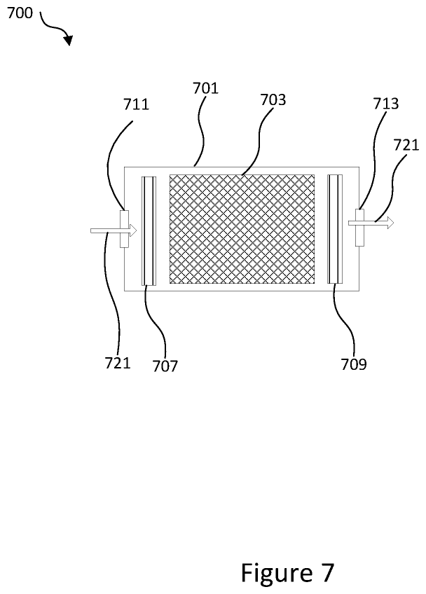

While the examples shown in FIGS. 1 to 6 show two stacks 103, 105 of battery cells, it will be understood that in some examples battery packs 100 may comprise more or fewer stacks. For example, as shown in FIG. 7, the battery pack 701 only comprises one stack 703 of battery cells. Otherwise the battery pack 701 is in many respects identical to that of FIGS. 1 to 6, with two heat exchangers 707, 709 and two fans 711, 713. However, it will also be understood that in some example there may be only one fan and one heat exchanger.

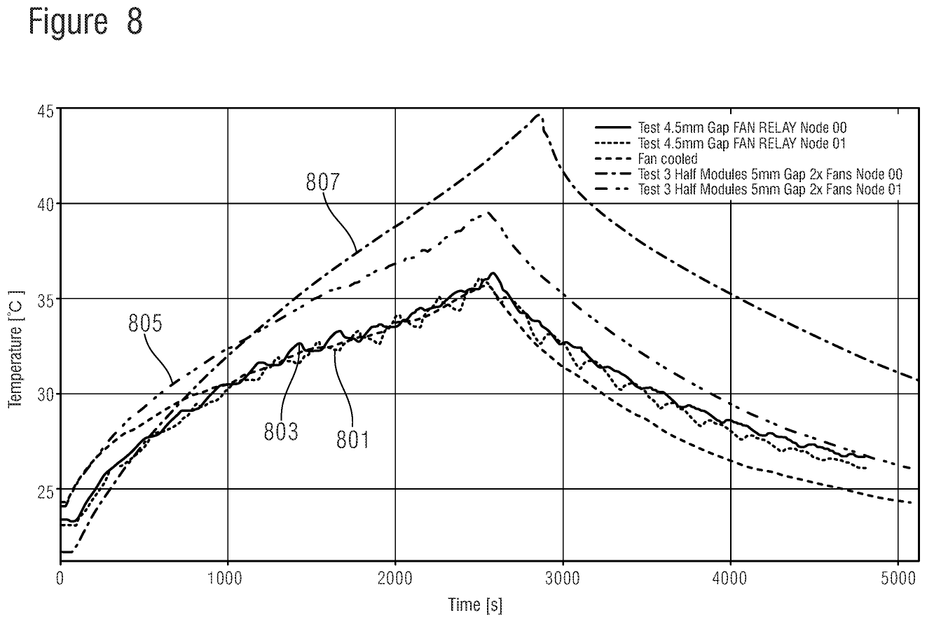

FIG. 8 shows a graph illustrating the temperature of cells in the battery back when cooled using methods of the disclosure comprising alternating the direction of cooling airflow compared to methods where the direction of cooling airflow is kept constant. In the example shown in FIG. 8, the cooling means comprise fans that are controlled to produce an airflow. The plots of the graph show the temperature of respective nodes positioned adjacent to cells of corresponding stacks of battery packs. The plot labelled 801 indicates the temperature of a first node for a first stack and the plot labelled 803 indicates the temperature of a second node for a second stack wherein fans are controlled to operate in alternating directions, such that the airflow is produced in each direction for a selected time period of two minutes. The plots labelled 805 and 807 show examples where fan cooling of the battery stacks did not alternate in direction. For example, plot labelled 805 shows the temperature of a first node for a first stack and plot labelled 807 shows the temperature of a second node for a second stack, where the fans are controlled to operate in the same direction. It can be seen that by using cooling methods of the disclosure where the airflow direction of active cooling alternates, the peak temperature of both stacks of batteries is reduced.

In some examples the controller is configured to operate the active cooling means (such as the fans 100) to blow air in each direction for a selected threshold minimum period of time. The selected threshold minimum period of time may be based on the parameter indicative of temperature or may be based on something else, such as operating constraints of the active cooling means. For example, the threshold minimum period of time may be based on the time taken for the fans 111, 113 to spin up to their effective operating speed.

It will be understood that in some examples the controller is further configured to control the active cooling means (such as the fans 111, 113) based on ambient temperature. For example, if the battery pack is operating in extremely hot or cold conditions, the interval between reversals of airflow direction may be decreased or increased respectively.

In some examples the controller is configured to operate both fans 111, 113 for a selected period of time when the first fan is being run up to a first fan 111 selected operating speed and the second fan 113 is being run down from a second fan selected operating speed, or when the second fan is being run up to the second fan 113 selected operating speed and the first fan 111 is being run down from the first fan selected operating speed. This may be advantageous as, when a fan is being run up to speed it may not be capable of effecting a sufficiently strong airflow through the enclosure, and so by controlling both fans to operate at the same time while one is being run up and the other down may ensure that a consistently effective airflow is always passing through the enclosure 101.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein.

The methods and apparatus outlined herein may be implemented using controllers and/or processors which may be provided by fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

It will be appreciated from the discussion above that the embodiments shown in the Figures are merely exemplary, and include features which may be generalised, removed or replaced as described herein and as set out in the claims. In the context of the present disclosure other examples and variations of the apparatus and methods described herein will be apparent to a person of skill in the art.

1. A battery pack comprising an enclosure housing at least one stack of battery cells; and
active cooling means configured to blow air over the at least one stack of battery cells in a first airflow direction through the enclosure and a second airflow direction through the enclosure opposite to the first airflow direction;
wherein the active cooling means is coupled to a controller and wherein the controller is configured to control the active cooling means to alternate between the first airflow direction and the second airflow direction based on a parameter indicative of the temperature of the at least one stack of battery cells.

2. The battery pack of claim 1 comprising a first stack of battery cells and a second stack of battery cells, and wherein the active cooling means comprises a first fan configured to blow air predominantly over the first stack of battery cells in the first airflow direction, and a second fan configured to blow air predominantly over the second stack of battery cells in the second airflow direction.

3. The battery pack of claim 2 wherein the controller is configured to determine whether to control the active cooling means to blow air predominantly over the first stack of battery cells or the second stack of battery cells based on a temperature differential between the first stack of battery cells and the second stack of battery cells.

4. The battery pack of claim 1, 2 or 3 wherein the controller is configured to operate in two modes;
in a first mode where the active cooling means are not powered when the parameter indicative of the temperature indicates that the temperature of the cells is below a selected temperature threshold; and
in a second mode where the controller controls the direction of airflow from the active cooling means based on a parameter indicative of the temperature of the at least one stack of battery cells when the parameter indicative of the temperature indicates that the temperature of the cells is equal to and/or above the selected temperature threshold.

5. The battery pack of any one of the previous claims wherein the parameter indicative of a temperature comprises at least one of:
the current draw from the battery cells;
a selected time interval;
a temperature gradient across the cells of the battery cells; and
whether the cells are being charged or discharged and optionally the duration of the charge or discharge.

6. The battery pack of any of the previous claims wherein the controller is configured to determine the temperature of the cells of the battery pack based on an indication of whether the cells and being charged or discharged and the corresponding current flow to/from the cells, and by referencing a lookup table listing known relationships between duration of charge and discharge, current flow and temperature.

7. The battery pack of any of the previous claims wherein the controller is further configured to control the active cooling means based on ambient temperature.

8. The battery pack of any of the previous claims wherein the controller is configured to operate the active cooling means to blow air in each direction for a selected threshold minimum period of time.

9. The battery pack of claim 2 or any claim as dependent thereon wherein the first fan is configured to blow air over a corresponding first heat exchanger and the second fan is configured to blow air over a corresponding second heat exchanger.

10. The battery pack of any of the previous claim wherein the active cooling means and orientation of the at least one stack of battery cells is arranged so that the active cooling means blows air along a thin edge of each cell of the stack of battery cells

11. The battery pack of claim 2 or any claim as dependent thereon wherein the controller is configured to control the two fans so that they either both blow air in the first airflow direction or both blow air in the second airflow direction.

12. The battery pack of claim 2, or any of claims 3 to 10 as dependent thereon, wherein the controller is configured to control the first fan and second fan such that when the controller controls the first fan to blow air in the first airflow direction the second fan is not operating, and when the controller controls the second fan to blow air in the second airflow direction the first fan is not operating.

13. The battery pack of claim 12 wherein the controller is configured to operate both fans for a selected period of time when the first fan is being run up to a first fan selected operating speed and the second fan is being run down from a second fan selected operating speed, or when the second fan is being run up to the second fan selected operating speed and the first fan is being run down from the first fan selected operating speed.

14. The battery pack of any of the previous claims wherein the enclosure is elongate such that an elongate dimension is greater than the other dimensions, and wherein the first and second airflow directions are parallel to the elongate dimension.

15. A hermetic enclosure comprising a plurality of the battery packs of any of the preceding claims.

16. The hermetic enclosure of claim 15 wherein the hermetic enclosure comprises the controller and wherein the controller is a master controller common to the plurality of battery packs.

17. The hermetic enclosure of claim 15 wherein each battery pack comprises a respective controller for controlling its corresponding active cooling means.

18. The hermetic enclosure of any of claims 15 to 17 wherein each battery pack comprises a heat exchanger fed with a common coolant.

19. A power pack for providing electric power to rolling stock, the power pack comprising a hermetic enclosure housing a plurality of battery packs;
wherein each battery pack comprises:
an enclosure housing at least one stack of battery cells; and
active cooling means configured to blow air through the enclosure over the at least one stack of battery cells in a first airflow direction and a second airflow direction opposite to the first airflow direction.

20. The power pack of claim 19 further comprising a master controller configured to control the active cooling means of the plurality of battery packs to alternate between the first airflow direction and the second airflow direction based on a parameter indicative of the temperature of the at least one stack of battery cells of each battery pack.

21. The power pack of claim 20 wherein the master controller is configured to independently control the active cooling means of each battery pack.

22. The power pack of claim 19 wherein each battery pack comprises a respective controller for controlling its corresponding active cooling means.

23. A method of operating a power pack for rolling stock, the power pack comprising a hermetic enclosure housing a plurality of battery packs, wherein each battery pack comprises an enclosure housing at least one stack of battery cells, and active cooling means,
the method comprising operating the active cooling means to blow air through the enclosure over the at least one stack of battery cells in a first airflow direction and then operating the active cooling means to blow air through the enclosure over the at least one stack of battery cells in a second airflow direction opposite to the first airflow direction.

24. The method of claim 23 comprising operating the active cooling means to blow air in the first airflow direction and the second airflow direction based on a parameter indicative of the temperature of the battery cells of each pack.

25. The method of claim 24 wherein the parameter indicative of the temperature of the battery cells of each pack comprises a torque demand of the rolling stock.

26. The method of any of claims 23 to 25 comprising controlling the active cooling means of each pack based on an indication of a temperature of the corresponding battery cells in each pack.

27. The method of any of claims 23 to 25 comprising controlling the active cooling means of all of the plurality of battery packs based on an indication of an average temperature of the battery cells of the plurality of battery packs.

28. The method of any of claims 23 to 27 wherein each battery pack comprises at least two stacks of battery cells, and wherein controlling the active cooling means comprises controlling the active cooling means to predominantly cool the first stack of battery cells and then controlling the active cooling means to predominantly cool the second stack of battery cells.

29. The method of claim 28 wherein the method comprises determining whether to control the active cooling means to predominantly cool the first or second stack of battery cells based on a temperature differential between the first and second stack of battery cells.

30. The method of claim 24 or any claim as dependent thereon comprising operating the active cooling in means in two modes;
in a first mode where the active cooling means are not powered when the parameter indicative of the temperature indicates that the temperature of the cells is below a selected temperature threshold; and
in a second mode where the direction of airflow from the active cooling means is controlled based on a parameter indicative of the temperature of the at least one stack of battery cells when the parameter indicative of the temperature indicates that the temperature of the cells is equal to and/or above the selected temperature threshold.

31. A method of operating active cooling means for a battery pack, the active cooling means arranged to blow air through an enclosure housing at least two stacks of battery cells in a first airflow direction and a second airflow direction opposite to the first airflow direction, the method comprising:
controlling the active cooling means to predominantly cool the first stack of battery cells; and then
controlling the active cooling means to predominantly cool the second stack of battery cells.

32. The method of claim 31 comprising operating the active cooling means based on a parameter indicative of the temperature of the battery cells of each pack.

33. The method of claim 31 or 32 wherein the method comprises controlling the active cooling means to predominantly cool the first or second stack of battery cells based on a temperature differential between the first and second stack of battery cells.

34. The method of claim 32, or claim 33 as dependent thereon, comprising operating the active cooling in means in two modes;
in a first mode where the active cooling means are not powered when the parameter indicative of the temperature indicates that the temperature of the cells is below a selected temperature threshold; and
in a second mode where the direction of airflow from the active cooling means is controlled based on a parameter indicative of the temperature of the at least one stack of battery cells when the parameter indicative of the temperature indicates that the temperature of the cells is equal to and/or above the selected temperature threshold.

35. A computer readable non-transitory storage medium comprising a program for a computer configured to cause a processor to perform the method of any of claims 23 to 34.
